(19) United States
(12) Patent Application Publication
(10) Pub. No.: US 2013/0125811 A1
(43) Pub. Date: May 23, 2013

(54) SUPPORT MECHANISM AND VACUUMM COATING MACHINE USING THE SAME

(71) Applicant: Juin-Hong LIN, Tu-Cheng (TW)

(72) Inventor: Juin-Hong LIN, Tu-Cheng (TW)

(73) Assignee: HON HAI PRECISION INDUSTRY CO., LTD., Tu-Cheng (TW)

(21) Appl. No.: 13/372,066

(22) Filed: Feb. 13, 2012

(30) Foreign Application Priority Data
Nov. 22, 2011 (TW) 100142642

(51) Int. Cl. B05C 9/08; F16M 11/00

(52) U.S. Cl. 118/50; 248/346.06

(57) ABSTRACT

A support mechanism includes a base plate, a plurality of mounting members and a plurality of adjusting members. The base plate defines a plurality of receiving holes, and each mounting member is received in one receiving hole. The adjusting members adjustably engage with the mounting members and resist on the base plate, and the plurality of adjusting members are capable of adjusting the height and tilt angle of the mounting members. The present invention further discloses a vacuum coating machine using the support mechanism.

### BACKGROUND

1. Technical Field

The present disclosure relates to support mechanisms and a vacuum coating machine using the support mechanism.

2. Description of Related Art

Vacuum coating machines are commonly employed to form coating layers on workpieces. A vacuum coating machine generally includes an emitting source, a support mechanism, and a pair of block members. The support mechanism includes a spherical support plate to support the workpieces. The support plate defines a plurality of receiving holes. The receiving holes are arranged in loops around the center of the support plate, and the loops of the receiving holes are spaced from each other evenly. The workpieces are received in the plurality of receiving holes respectively. The pair of block members is positioned between the support plate and the emitting source. When the support mechanism drives the workpieces to rotate, a target is emitted by the emitting source to the workpieces to form a coating layer on the surface of each workpiece. The block members are capable of shielding the loops of receiving holes under different extents, to enable the coating layers to maintain a same thickness on the workpieces. However, the edges of each receiving holes are easily deformed and bent, the workpieces received in the receiving holes of each loop have different tilt angles and heights, and thus the coating layer formed on the workpieces have different thicknesses.

Therefore, there is room for improvement in the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is a cross-section of an embodiment of a vacuum coating machine.

FIG. 2 is a cross-section of a portion of the support mechanism of the vacuum coating machine of FIG. 1.

FIG. 3 is a top view of the mounting member and the adjusting member of the vacuum coating machine of FIG. 1.

FIG. 4 is a cross-section of a portion of the support mechanism of a second embodiment.

FIG. 5 is a cross-section of a portion of the support mechanism of a third embodiment.

### DETAILED DESCRIPTION

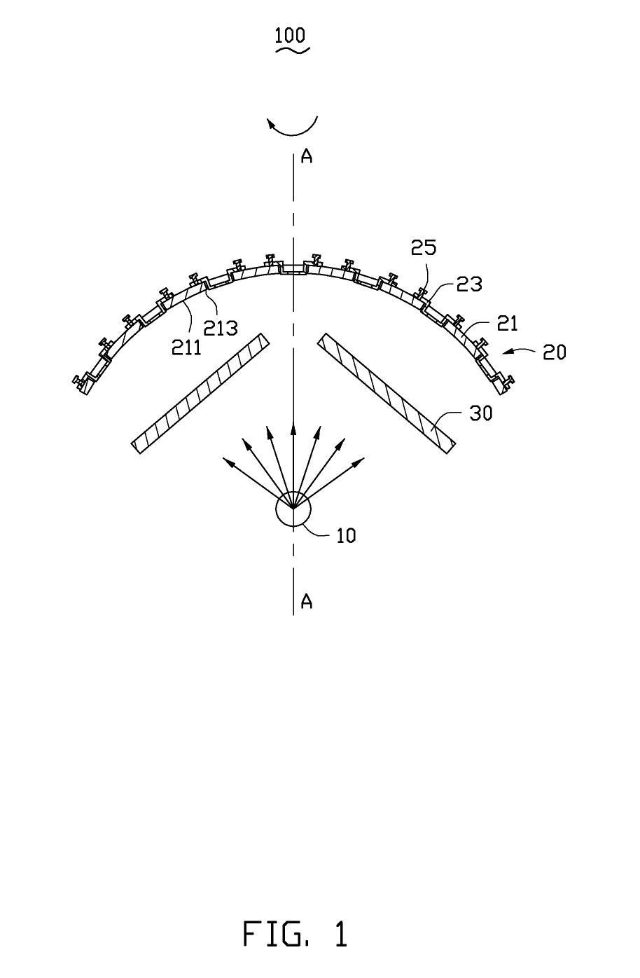

Referring to FIG. 1, a first embodiment of a vacuum coating machine 100 includes an emitting source 10, a support mechanism 20 rotatably located above the emitting source 10, and a pair of block members 30 positioned between the emitting source 10 and the support mechanism 20.

The emitting source 10 is capable of heating and emitting a target to cover or coat a plurality of workpieces (not shown) received in the support mechanism 20. The emitting source 10 heats the target for emitting via resistant heating or high frequency induction heating. In addition, electron beam heating may be also employed to heat the target.

The support mechanism 20 includes a base plate 21, a plurality of mounting members 23, and a plurality of adjusting members 25 corresponding to the plurality of mounting members 23. The base plate 21 is a substantially spherical plate, and is capable of rotating along an axis A-A. The axis A-A is a connection line formed through the center of the base plate 21 and the center of the emitting source 10, respectively. The base plate 21 includes an inner receiving surface 211 and defines a plurality of receiving holes 213 on the receiving surface 211. The receiving holes 213 are arranged in a plurality of loops around the center of the base plate 21, and the loops of the receiving holes 213 are spaced from each other evenly. The plurality of mounting members 23 are received in the receiving holes 213 respectively, the plurality of adjusting members 25 are mounted on the mounting members 23 and resisted on the base plate 21 to adjust the tilt angle and height of each mounting member 23.

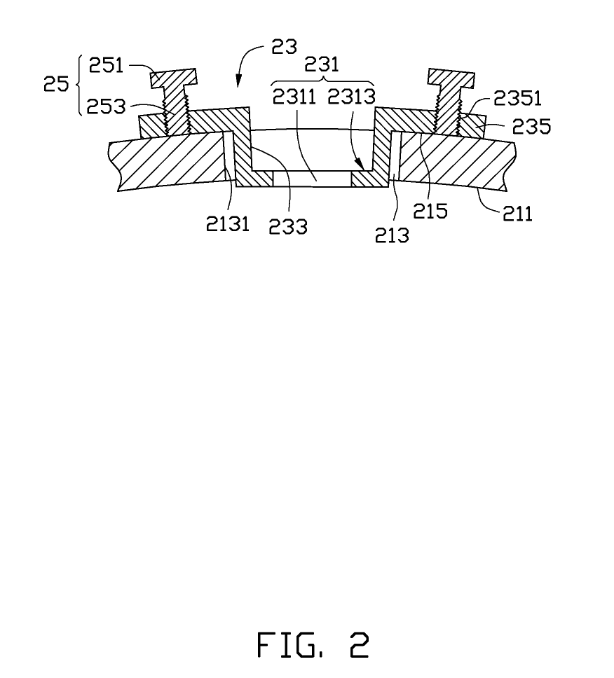

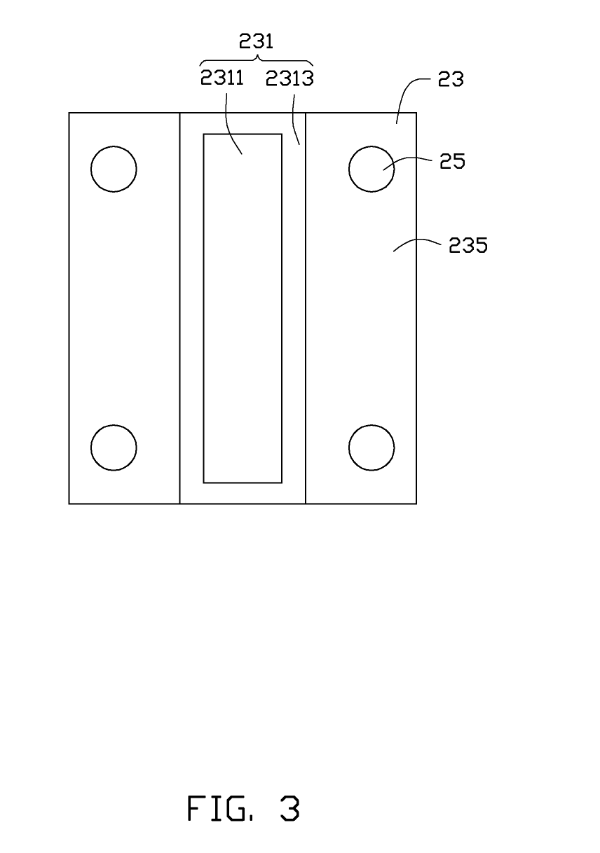

Also referring to FIGS. 2 and 3, the receiving surface 211 is a substantially spherical surface facing the emitting source 10. The plurality of loops of the receiving holes 213 are arranged along the radial direction of the base plate 21. Each receiving hole 213 is a rectangular through hole. The base plate 21 includes a pair of resisting portions 215 at two edges of each receiving hole 213, and a pair of restricting surfaces 2131 corresponding to the pair of resisting portions 215. The two restricting surfaces 2131 are located at opposite sides of each receiving hole 213, and facing each other.

The mounting member 23 is a substantially bent rectangular plate, and includes a receiving portion 231, two sidewalls 233 substantially perpendicular to the receiving portion 231 and two extending portions 235 extending from the two sidewalls 233. Each receiving portion 231 is received in one receiving hole 213 and defines an emitting hole 2311 formed in the middle of the receiving portion 231. The receiving portion 231 further includes a support frame 2313 surrounding the emitting hole 2311. The emitting hole 2311 is a substantially rectangular through hole. The support frame 2313 is substantially rectangular and includes four integrally formed bars. The two sidewalls 233 are bent from opposite sides of the support frame 2313 and extended toward a same direction substantially perpendicular to the support frame 2313. The two sidewalls 233 have a same height, and a maximum distance between the two sidewalls 233 is less than a distance between the two restricting surfaces 2131 of one receiving hole 213. The extending portion 235 and the receiving portion 231 are located at two sides of a sidewall 233. The two extending portions 235 extend from the two sidewalls 233 along two opposite directions. Each extending portion 235 is a substantially planar plate, and bent from a top edge of the corresponding sidewall 233. The two extending portions 235 are capable of resisting on the two resisting portions 215 to support the mounting member 23. Each extending portion 235 defines two adjusting holes 2351 adjacent to two ends thereof. In the embodiment, the adjusting hole 2351 is a screwed hole, and the mounting member 23 is formed by punching.

The adjusting member 25 is received in and engaged with a corresponding adjusting hole 2351 to adjust the tilt angle and the height of the mounting member 23. The adjusting member 25 includes a head portion 251 and an adjusting portion 253 connected to the head portion 251. The head portion 251 has a disk-shape, and the adjusting portion 253 has a rod shape. A diameter of the head portion 251 is greater than the diameter of the adjusting portion 253. The adjusting portion 253 engages in the adjusting hole 2351, and the end portion of the adjusting member 25 resists on the resisting portion 215 to support the mounting member 23. In the embodiment, the adjusting member 25 is a screw.

The pair of block members 30 is mounted between the emitting source 10 and the support mechanism 20. The two block members 30 are symmetrically configured relative to the axis A-A. Each block member 30 is an elliptical plate, and is inclined toward the center of the emitting source 10.

When in use, a plurality of workpieces are received in the receiving portions 231 of the mounting member 23, the periphery of each workpiece is supported by the support frame 2313. The portions of each workpiece to be coated are exposed in the emitting hole 2311. When an external force is applied on the adjusting member 25, the adjusting member 25 rotates, such that the height of an end of the mounting member 23 is adjusted. The four adjusting members 25 are adjusted one by one, and the tilt angle and height of one mounting member 23 are thereby adjusted. Maintaining the tilt angle and the height of the mounting members 23 in one loop to being the same, the support mechanism 20 is then rotated. The emitting source 10 is heated and emits a target to the workpieces to form a coating layer on each workpiece. In the vacuum coating process, the two block members 30 block the loops of workpieces on the base plate 21 from the reach of target bombardment to some extent, to maintain the thicknesses of the coating layers on workpieces to be substantially the same.

The tilt angle and the height of the mounting members 23 can be adjusted by the adjusting members 25. Thus, the vacuum coating machine 100 is capable of keeping the thicknesses of the coating layers formed on the workpieces more evenly, and avoids the negative influences of deformation and bending of the edges of the receiving holes 213.

It should be noted that if the deformation and bending of the edges of some receiving holes 213 has no effect on the tilt angle and the height of the workpieces received therein, the adjusting process of corresponding mounting members 23 can thereby be omitted. It should be noted that each extending portion 235 may define a plurality of adjusting holes 2351, and the adjusting holes 2351 formed in two extending portions 235 of each of the mounting members 23 are symmetrical. Accordingly, the number of the adjusting members 25 may be equal to the number of the adjusting holes 2351.

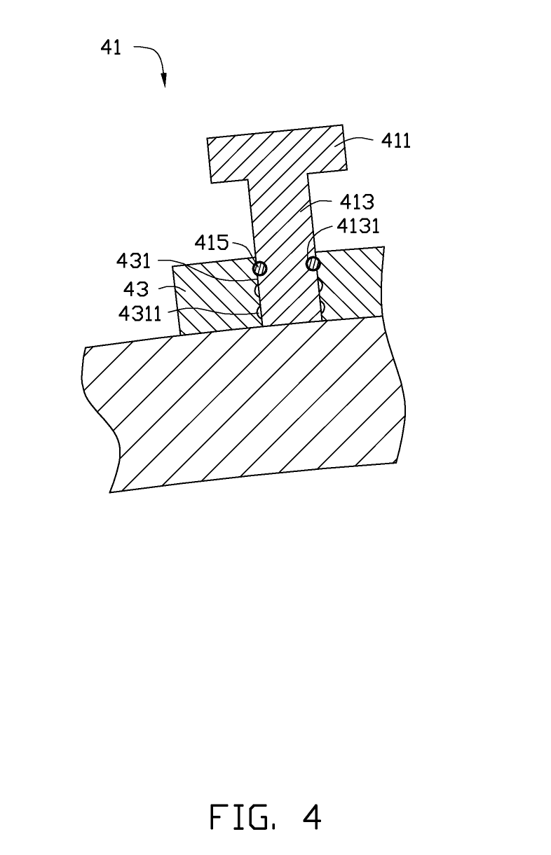

Referring to FIG. 4, a second embodiment of a vacuum coating machine similar in principle to the first embodiment of the vacuum coating machine 100 is shown. However, the vacuum coating machine in the second embodiment includes a support mechanism (not labeled) having a different structure. The support mechanism includes an adjusting member 41. An adjusting portion 413 of the adjusting member 41 defines a pair of receiving recesses 4131, and includes a resilient sidewall (not labeled) in each receiving recess 4131. The adjusting member 41 further includes a pair of positioning balls 415 rotatably received in the two receiving recesses 4131 respectively. A mounting member 43 defines an adjusting hole 431 and a plurality of pairs of positioning grooves 4311 formed in the inner side surface of the adjusting hole 431. The pairs of positioning grooves 4311 are located at a plurality of different heights of the adjusting hole 431. The adjusting portion 413 is received in the adjusting hole 431 and each positioning ball 415 is rotatably contained between a receiving recess 4131 and a corresponding positioning groove 4311. When the head portion 411 of the adjusting member 41 is subjected to be exerted by an external force, the pair of the positioning balls 415 is capable of engaging in another pair of the positioning grooves 4311, thus the height of an end of the mounting member 43 is thereby adjusted.

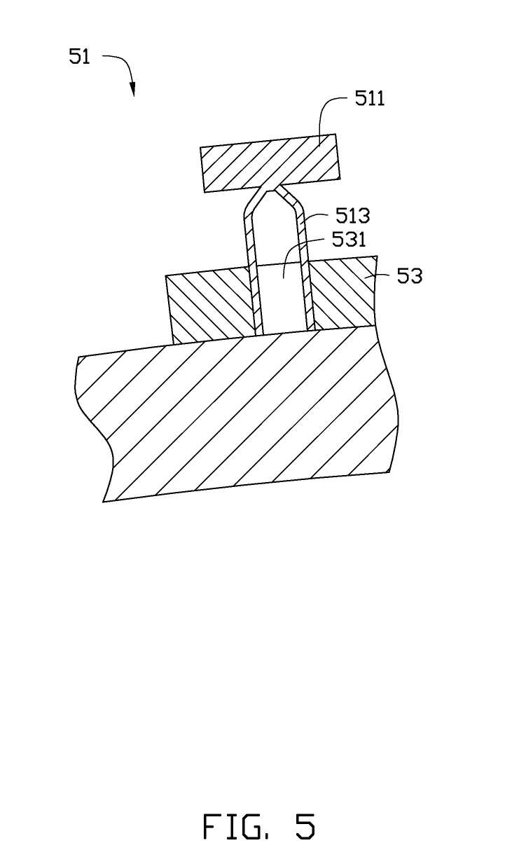

Referring to FIG. 5, a third embodiment of a vacuum coating machine similar in principle to the first embodiment of the vacuum coating machine 100 is shown. However, the vacuum coating machine in the third embodiment includes a support mechanism with a different structure, the support mechanism includes an adjusting member 51. The adjusting member 51 includes a head portion 511 and a pair of resilient supporting clips 513 extending from an end of the head portion 511. The pair of supporting clips 513 are symmetrical, and are bent away from each other. The pair of supporting clips 513 is pushed toward each other, and extended into the adjusting hole 531 of the mounting member 53. The supporting clips 513 are released and resisted on the sidewall of the adjusting hole 531. The ends of the pair of the supporting clips 513 resist on the base plate (not labeled) to support the mounting member 53. When the head portion 511 of the adjusting member 51 is pulled by an external force, the support clips 513 are capable of moving relative to the adjusting hole 531, thus the height of an end of the mounting member 53 is thereby adjusted.

Finally, while various embodiments have been described and illustrated, the disclosure is not to be construed as being restricted thereto. Various modifications can be made to the embodiments by those skilled in the art without departing from the true spirit and scope of the disclosure as defined by the appended claims.

What is claimed is:

1. A support mechanism, comprising:
a base plate defining at least one receiving hole;
at least one mounting member received in the at least one receiving hole; and
a plurality of adjusting members mounted on the at least one mounting member, the plurality of adjusting members adjustably engaging with the at least one mounting member and resisting on the base plate, and being capable of adjusting the height and tilt angle of the at least one mounting member.

2. The support mechanism of claim 1, wherein the at least one mounting member comprises a receiving portion, two sidewalls substantially perpendicular to the receiving portion and two extending portions extending from the two sidewalls respectively, and the receiving portion is received in the at least one receiving hole of the base plate.

3. The support mechanism of claim 2, wherein the receiving portion defines an emitting hole in the middle thereof and comprises a support frame surrounding the emitting hole, the base plate comprises a pair of resisting portions at two edges of the at least one receiving hole, the two extending portions are capable of resisting the two resisting portions to support the at least one mounting member.

4. The support mechanism of claim 3, wherein the base plate further comprises a pair of restricting surfaces located at opposite sides of the at least one receiving hole corresponding to the pair of resisting portions respectively, the two sidewalls are bent from opposite sides of the support frame and extended toward a same direction substantially perpendicular to the support frame, and a maximum distance between the two sidewalls is less than a distance between the two restricting surfaces.

5. The support mechanism of claim 3, wherein each extending portion defines at least two adjusting holes adjacent to two ends thereof, each adjusting member comprises a head portion and an adjusting portion connected to the head portion, the adjusting portion engages in one corresponding adjusting hole, the end portion of the adjusting member resists on one corresponding resisting portion to support the mounting member.

6. The support mechanism of claim 3, wherein each extending portion defines at least two adjusting holes adjacent to two ends thereof, each adjusting member comprises a head portion and an adjusting portion connected to the head portion, the adjusting portion defines a pair of receiving recesses and comprises a resilient sidewall in each receiving recess, the adjusting member further comprises a pair of positioning balls rotatably received in the two receiving recesses respectively, the at least one mounting member defines a plurality of pairs of positioning grooves in the inner side surface of each adjusting hole at different heights, and when an external force is applied to the head portion, the pair of the positioning balls are capable of engaging in another pair of the positioning grooves to adjust the height of an end of the mounting member.

7. The support mechanism of claim 3, wherein each extending portion defines at least two adjusting holes adjacent to two ends thereof, each adjusting member comprises a head portion and a pair of resilient supporting clips extending from an end of the head portion, the pair of supporting clips is bent away from each other and extended into the adjusting hole of the at least one mounting member, and resist on the sidewalls of one corresponding adjusting hole; the ends of the pair of the supporting clips resist on the base plate to support the at least one mounting member, and when the head portion is pulled by an external force, the support clips are capable of moving relative to the adjusting hole to adjust the height of an end of the mounting member.

8. The support mechanism of claim 1, wherein the base plate is a substantially spherical plate and capable of rotating along an axis, the base plate comprises an inner receiving surface, and defines a plurality of receiving holes, the plurality of receiving holes are defined on the receiving surface and arranged in a plurality of loops around the center of the base plate, the loops of receiving holes are spaced from each other evenly, and the plurality of mounting members are received in the plurality of receiving holes respectively.

9. A vacuum coating machine, comprising:
an emitting source;
a support mechanism shielding the emitting source, the support mechanism comprising:
a base plate defining a plurality of receiving holes arranged in a plurality of loops around the center of the base plate;
a plurality of mounting members received in the plurality of receiving holes respectively; and
a plurality of adjusting members mounted on the plurality of mounting members, the plurality of adjusting members adjustably engaging with the plurality of mounting members and resisting on the base plate, and being capable of adjusting the height and tilt angle of the plurality of mounting members; and
a pair of block members positioned between the emitting source and the support mechanism.

10. The vacuum coating machine of claim 9, wherein each of the plurality of mounting members comprises a receiving portion, two sidewalls substantially perpendicular to the receiving portion and two extending portions extending from the two sidewalls respectively, the receiving portion is received in one corresponding receiving hole of the base plate.

11. The vacuum coating machine of claim 10, wherein the receiving portion defines an emitting hole in the middle thereof and comprises a support frame surrounding the emitting hole, the base plate comprises a pair of resisting portions at two edges of each receiving hole, the two extending portions are capable of resisting on the two resisting portions to support the one corresponding mounting member.

12. The vacuum coating machine of claim 11, wherein the base plate further comprises a pair of restricting surfaces corresponding to the pair of resisting portions, the pair of restricting surfaces is located at two opposite sides of the receiving holes, the two sidewalls are bent from opposite sides of the support frame and are extended toward a same direction substantially perpendicular to the support frame, and a maximum distance between the two sidewalls is less than a distance between the two restricting surfaces of the one corresponding receiving hole.

13. The vacuum coating machine of claim 11, wherein each extending portion defines at least two adjusting holes adjacent to two ends thereof, each adjusting member comprises a head portion and an adjusting portion connected to the head portion, the adjusting portion engages in one corresponding adjusting hole, and the end portion of the adjusting member resists on one corresponding resisting portion to support the mounting member.

14. The vacuum coating machine of claim 11, wherein each extending portion defines at least two adjusting holes adjacent to two ends thereof, the adjusting member comprises a head portion and an adjusting portion connected to the head portion, the adjusting portion defines a pair of receiving recesses and comprises a resilient sidewall in each receiving recess, the adjusting member further comprises a pair of positioning balls rotatably received in the two receiving recesses, respectively, the mounting member defines a plurality of pairs of positioning grooves in the inner side surface of each adjusting hole at different heights, and when an external force is applied to the head portion, the pair of the positioning balls are capable of engaging in another pair of the positioning grooves to adjust the height of an end of the mounting member.

15. The vacuum coating machine of claim 11, wherein each extending portion defines at least two adjusting holes adjacent to two ends thereof, the adjusting member comprises a head portion and a pair of resilient supporting clips extending from an end of the head portion, the pair of supporting clips are bent away from each other and extended into the adjusting hole of the mounting member, and resist on the sidewall of the adjusting hole; the ends of the pair of the supporting clips resist on the base plate to support one corresponding mounting member, and when the head portion is pulled by an external force, the support clips are capable of moving relative to adjust the height of an end of the mounting member.

16. The vacuum coating machine of claim 9, wherein the base plate is a substantially spherical plate and capable of rotating along an axis, the axis is a connection line formed through the center of the base plate and the center of the emitting source, respectively, the base plate comprises an inner receiving surface, the plurality of receiving holes are defined on the receiving surface, and the loops of the receiving holes are spaced from each other evenly.

17. The vacuum coating machine of claim 16, wherein the pair of block members are mounted between the emitting source and the support mechanism, and the two block members are symmetrically configured relative to the axis, and each block member is an elliptical plate, and inclines toward the center of the emitting source.
